(19) United States
(12) Patent Application Publication
(10) Pub. No.: US 2019/0198189 A1
(43) Pub. Date: Jun. 27, 2019

(54) CONDUCTIVE POLYMER DISPERSION FOR CAPACITOR AND CAPACITOR PACKAGE STRUCTURE

(71) Applicant: APAQ TECHNOLOGY CO., LTD., Miaoli County (TW)

(72) Inventors: CHIEH LIN, HSINCHU COUNTY (TW); MING-TSUNG CHEN, CHANGHUA COUNTY (TW)

(21) Appl. No.: 16/220,600

(22) Filed: Dec. 14, 2018

(30) Foreign Application Priority Data
Dec. 25, 2017 (TW) 106145554

(51) Int. Cl. H01B 1/12; H01G 4/008; C08L 101/12; C08J 3/05; C08J 3/09

(52) U.S. Cl. CPC H01B 1/127; H01G 4/008; C08J 2300/12; C08J 3/05; C08J 3/095; C08L 101/12

(57) ABSTRACT

A conductive polymer dispersion for capacitors and a capacitor package structure is provided. The conductive polymer dispersion includes a conductive polymer, a dispersing agent and an additive. The conductive polymer has a transmittance spectrum obtained by a UV-visible spectrometry, and the transmittance spectrum includes a first peak located between 350 nm and 450 nm and a second peak located between 300 nm and 400 nm.

### CROSS-REFERENCE TO RELATED PATENT APPLICATION

This application claims the benefit of priority to Taiwan Patent Application No. 106145554, filed on Dec. 25, 2017. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a dispersion and a package structure using the same, and more particularly to a conductive polymer dispersion for capacitor and capacitor package structure using the same.

### BACKGROUND OF THE DISCLOSURE

Capacitors are widely used in consumer appliances, computers, power supplies, communication products and vehicles, and hence, are important elements for electronic devices. The main functions of capacitors are filtering, bypassing, rectification, coupling, decoupling and phase inverting, etc. Capacitors have different types according to different materials and uses, including aluminum electrolytic capacitors, tantalum electrolytic capacitors, laminated ceramic capacitors, and film capacitors. In the existing art, solid electrolytic capacitors have the advantages of small size, large capacitance and excellent frequency property and can be used in the decoupling of power circuits of central processing units. Solid electrolytic capacitors use solid electrolytes instead of liquid electrolytic solutions as cathodes. Conductive polymers are suitable for the cathode material of the capacitors due to its high conductivity, and the manufacturing process using conductive polymers are simple and low cost. However, the capacitors in the existing art still have disadvantages to be improved.

### SUMMARY OF THE DISCLOSURE

The present disclosure provides a conductive polymer dispersion for capacitor, wherein, the conductive polymer dispersion has a transmittance spectrum obtained by a UV-visible spectrometry and the transmittance spectrum includes a first peak located between 350 nm and 450 nm and a second peak located between 300 nm and 400 nm.

In one aspect, the present disclosure provides a capacitor package structure including at least one electrode body with a conductive polymer coating formed by a conductive polymer dispersion; wherein, the conductive polymer dispersion has a transmittance spectrum obtained by a UV-visible spectrometry and the transmittance spectrum has a first peak located between 350 nm and 450 nm and a second peak located between 300 nm and 400 nm

Therefore, the advantage of the present disclosure resides in that the conductive polymer dispersion for capacitor and the capacitor package structure can improve the electrical properties of the solid electrolytic capacitor based on the technical feature of “the transmittance spectrum has a first peak located between 350 nm and 450 nm and a second peak located between 300 nm and 400 nm”, such as improvements of: improving conductivity, improving thermal stability, increasing polymer impregnation rate, increasing capacitance, reducing equivalent series resistance, reducing dissipation factor, and reducing leakage current etc. In addition, the method for forming the conductive polymer dispersion of the present disclosure is low in costs, thereby effectively reducing the overall manufacturing cost of the solid electrolytic capacitor.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a sectional schematic view of a capacitor package structure provided by an embodiment of the present disclosure.

FIG. 2 is a sectional schematic view of a capacitor element of the capacitor package structure provided by the embodiment of the present disclosure.

FIG. 3 is a transmission spectrum obtained by testing a conductive polymer dispersion for a capacitor using an ultraviolet-visible spectrometer provided by the embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

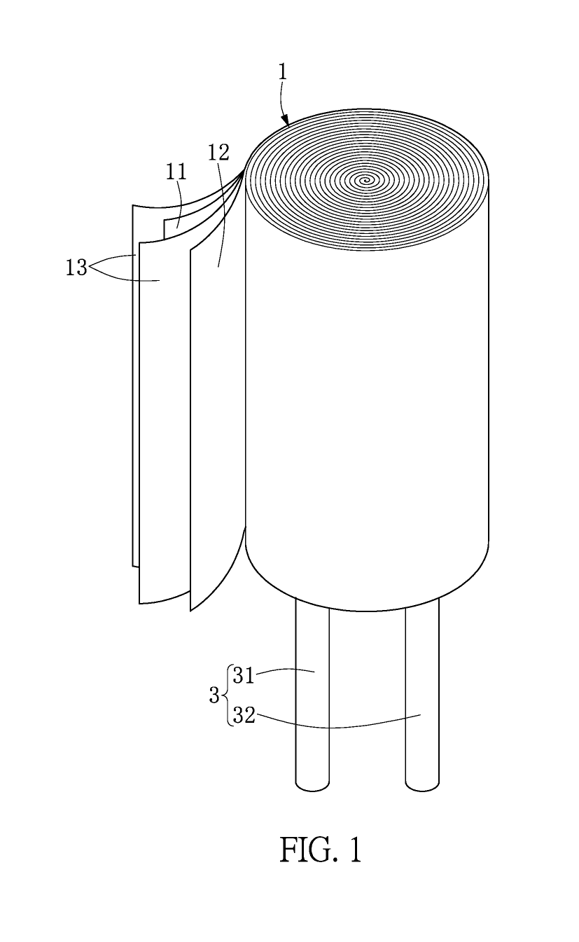

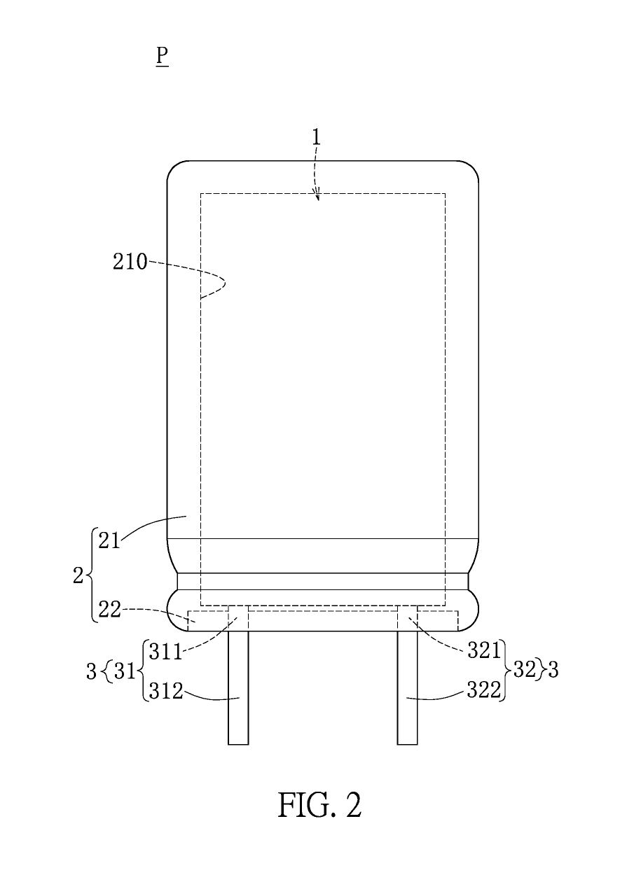

Firstly, reference is made to FIG. 1 and FIG. 2. FIG. 1 is a sectional schematic view of a capacitor package structure provided by an embodiment of the present disclosure, and FIG. 2 is a sectional schematic view of a capacitor element of the capacitor package structure provided by the embodiment of the present disclosure.

As shown in FIG. 1, the winding solid electrolytic capacitor package structure P includes a winding-type component 1, a packaging component 2 and a conductive component 3. The winding-type component 1 and the conductive component 3 together form the capacitor element E used in the present disclosure. The winding-type component 1 includes a winding-type positive conductive foil 11, a winding-type negative conductive foil 12 and two isolating foils 13. Furthermore, one of the two isolating foils 13 can be disposed between the winding-type positive conductive foil 11 and the winding-type negative conductive foil 12, and one of the winding-type positive conductive foil 11 and the winding-type negative conductive foil 12 can be disposed between the two isolating foils 13. In the embodiments of the present disclosure, the conductive polymer dispersion can be disposed on the winding-type positive conductive foil 11 or the winding negative conductive foil 12 to form a conductive polymer layer by coating.

For example, the conductive polymer dispersion provided by the embodiments of the present disclosure can be disposed on the outer surface or inside the winding-type component 1, and can percolate into vias on the surface of the winding-type component 1. In the embodiments of the present disclosure, the conductive polymer dispersion is disposed on the winding-type positive conductive foil 11 or the winding-type negative conductive foil 12 including titanium (Ti) or carbon (C).

As shown in FIG. 2, the winding-type component 1 can be enclosed in the packaging component 2. For example, the packaging component 2 includes a capacitor casing structure 21 (such as an aluminum casing or a casing made of other metals) and a bottom end sealing structure 22. The capacitor casing structure 21 has an accommodating space 210 for accommodating the winding-type component 1, and the bottom end sealing structure 22 is disposed at the bottom end of the capacitor casing structure 21 for sealing the accommodating space 210. In addition, the packaging component 2 can be a packaging body made of any insulating materials.

The conductive component 3 includes a first conductive pin 31 electrically contacting with the winding-type positive conductive foil 11 and a second conductive pin 32 electrically contacting the second conductive pin 32. For example, the first conductive pin 31 has a first embedded portion 311 enclosed in the packaging component 2 and a first exposed portion 312 exposed from the packaging component 2. The second conductive pin 32 has a second embedded portion 321 enclosed in the packaging component 2 and a second exposed portion 322 exposed from the packaging component 2.

Next, the conductive polymer dispersion for capacitor provided by the embodiments of the present disclosure is described herein. The conductive polymer dispersion for capacitor of the present disclosure includes a conductive polymer, a dispersing agent and an addition agent. The conductive polymer includes a conductive moiety and a dispersing moiety. The conductive moiety is selected from the group consisting of aniline, polypyrrole, polythiophene and polydioxyethylthiophene; and the dispersing moiety is polystyrene sulfonate (PSS). In addition, the conductive polymer may exist in the form of nano-sized particles and be well dispersed in the dispersing agent.

Furthermore, the conductive polymer in the conductive polymer dispersion for capacitor provided by the present disclosure may also be a conductive polymer modified by an emulsifier. For example, the emulsifier used to modify the conductive polymer can be selected from the group consisting of the following compounds: Polyol, cetyltrimethylammonium bromide (CTAB), dodecyltrimethylammonium bromide (DTAB), polyethylene glycol monostearate, dodecyl sulfate Sodium (SDS), sodium dodecylbenzene sulfonate (SDBS), oleic acid and its derivatives, glycerol monostearate, polyoxyethylene monooleate, polyoxyethylene (10EO) oleyl ether (POE (10) oleyl alcohol), sorbitan monolaurate, sorbitan monopalmitate, sorbitan monostearate, sorbitan tristearate, sorbiatan monooleate, sorbitan sesquiolate, sorbitan tribleate, polyoxyethylene oxypropylene oleate, polyoxyethylene sorbitol hexastearate, polyoxyethylene esters of mixed fatty and resin acids, polyoxyethylene sorbitol lanolin derivative, polyoxyethylene alkyl aryl ether, polyoxyethylene sorbitol beeswax Derivative), D-sorbital, polyoxyethylene monopalmitate, polyoxyethylene glycol monopalmitate, polyoxyethylene oxypropylene oleate, tetraethylene glycol monolaurate, polyoxyethylene monolaurate, polyoxyethylene lauryl ether, polyoxyethylene enemonooleate, polyoxyethylene monooleate, hoxaethylene glycol monostearate, propylene glycol fatty acid ester, polyoxyethylene oxypropylene stearate, N-cetyl N-ethyl morpholinium ethosulfate, Alkyl aryl sulfonate, polyoxypropylene stearate, polyoxyethylene laurylether, polyoxyethylene stearyl alcohol, diethylene glycol monolaurate, sorbitan monolaurate, sorbitan monopalmitate, ethylene glycol diglycidyl ether, polyethylene glycol diglycidyl ether, propanediol diglycidyl ether, polypropanediol diglycidyl ether, 1,2,3-Propanetriol glycidyl ethers and butanediol diglycidyl ether. Preferably, the emulsifier 21 is a polyol. More preferably, the emulsifier 21 is polyethylene glycol or polyglycerol. It should be noted that, in the present disclosure, the emulsifier can be a substance having the function of a surfactant, but the specific kind of the emulsifier is not limited thereto. In addition, a variety of different emulsifiers can be used simultaneously.

The dispersing agent of the present disclosure may be water or other organic solvents, such as alcohol. In an embodiment of the present disclosure, the dispersing agent is ethanol. Additionally, the conductive polymer dispersion may include one or more addition agent. The addition agent is selected from the group consisting of a conductive auxiliary agent, pH adjusting agent, a coagulator, a thickener, adhesive and a crosslinking agent.

For example, the conductive auxiliary agent can be a high boiling point solvent, such as ethylene glycol, glycerol, dimethyl hydrazine (DMSO), sorbitol or N-methylpyrrolidone (NMP). The pH adjusting agent may be ethanolamine, diethanolamine, triethanolamine, dimethylethanolamine, diamines such as ethylenediamine and propylenediamine, triamines or a mixture thereof. The pH adjusting agent may be sulfuric acid, nitric acid, acetic acid or p-toluenesulfonic acid. The coagulator may be various carboxylic acids, carboxylic acid polymers or polyacrylic acid. The thickener may be a high molecular weight polyethylene glycol or a hydrocarbyl cellulose, both with a molecular weight between 1000 and 40,000. The adhesive may be polyurethane, polyester, polyacrylate or polyvinyl alcohol. The crosslinking agent can be a decane coupling agent. However, the disclosure is not limited to the examples given above. The above contents are used only for exemplary purposes, and should not be taken as limiting the scope of the present disclosure.

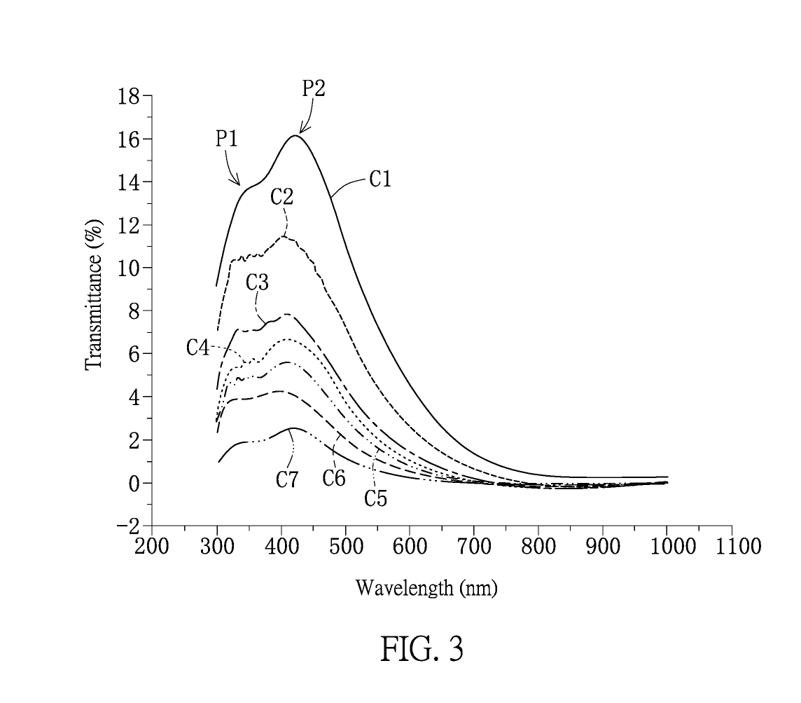

Reference is made to FIG. 3, which is a transmission spectrum of the conductive polymer dispersion for capacitor of the present disclosure obtained by a UV-visible spectrometry. The conductive polymer dispersion has a specific peak and transmittance spectrum obtained by a UV-visible spectrometry. Specifically, the transmittance spectrum has a first peak P1 located between 350 nm and 450 nm and a second peak P2 located between 300 nm and 400 nm.

As shown in FIG. 3, the conductive polymer dispersion formed by different manufacturing methods and different formulations provides different curves of the transmittance spectrum obtained by a UV-visible spectrometry.

In the present disclosure, the measurements were processed by the UV-visible spectrometer (Hitachi U-2900) to obtain different curves labeled C1-C7 in FIG. 3. The different conductive polymer dispersions are formed by adjusting at least one of the content ratio of the reactants, the polymerization temperature, the polymerization reaction time, and the content ratio of the initiator (for example, an oxidizing agent). It is worth mentioning that when measuring, the sample can be diluted with pure water to a concentration of 1/20 of the original concentration. In this way, the concentration of the original sample can be prevented from being too high to negatively affect the analysis and determination of the measured result.

As shown in FIG. 3, the transmittance spectrum has a first peak P1 located between 350 nm and 450 nm and a second peak P2 located between 300 nm and 400 nm. In the measurement curve of one sample, the transmittance of the first peak P1 is higher than the transmittance of the second peak P2.

It is worth mentioning that since the conductive polymer dispersion liquid including the conductive polymer has a large influence on the characteristics of the conductive polymer dispersion, such as the molecular weight, chain length, polymerization degree and the like of the conductive polymer, the present disclosure of the first peak P1 and the second peak P2 the conductive polymer dispersion must be controlled within the aforementioned predetermined range.

In fact, if the first peak P1 or the second peak P2 of the conductive polymer dispersion deviates from the predetermined range, the capacitor package structure P formed by the conductive polymer dispersion may have poor electrical properties. For example, the conductive polymer dispersion being used to form a capacitor may have poor equivalent series resistance (ESR) characteristics and the long-term reliability of the fabricated capacitor may be adversely affected when the first peak P1 or the second peak P2 of the conductive polymer dispersion deviate from the predetermined range described above. In other words, a conductive polymer dispersion that does not have the first peak P1 or the second peak P2 as above-mentioned would not be suitable for the manufacturing of the capacitor.

In addition, as shown in FIG. 3, the transmittance of the first peak P1 is less than 40%, and the transmittance of the second peak P2 is less than 35%. It is worth mentioning that the detection value for the transmittance here is a result obtained when the conductive polymer dispersion is diluted to 1/20 of the original concentration. In the present disclosure, the original concentration of the conductive polymer in the conductive polymer dispersion may be between 20 and 80 wt. %.

As shown in FIG. 3, the transmittance spectrum shows the transmittance of 12 types of concentrations of conductive polymer dispersion obtained by a UV-visible spectrometry. However, it is worth noting that the transmittance of the first peak P1 is less than 40%, and the transmittance of the second peak P2 is less than 35%. In one embodiment of the present disclosure, the transmittance of the first peak P1 is between 1% and 20%, and the transmittance of the second peak is between 2% and 16%.

In detail, when the transmittance of the first peak P1 and the transmittance of the second peak P2 are respectively within the above-mentioned range, the conductive polymer dispersion can be well applied to the capacitor. However, if the transmittance of the first peak P1 and the transmittance of the second peak P2 are too high, that is, respectively greater than 40% and 35%, it means that the amount of the conductive polymer in the conductive polymer dispersion is insufficient, or the chain length of the conductive polymer is too short. Therefore, the conductive polymer dispersion will have an adverse effect on the electrical properties of the capacitor. Specifically, when the transmittance of the first peak P1 of the conductive polymer dispersion is greater than 40%, or the transmittance of the second peak P2 is greater than 35%, the long-term reliability of the manufactured capacitor may be adversely affected, and the capacitor may have poor equivalent series resistance (ESR).

Referring to FIG. 3, in one embodiment of the disclosure, the ratio of the transmittance of the first peak P1 and the transmittance of the second peak P2 is between 1:1 and 1.25:1. Preferably, the ratio of the transmittance of the first peak P1 and the transmittance of the second peak P2 is between 1:1.1 and 1:1.2.

It is worth mentioning that the embodiment of the present disclosure further provides a capacitor package structure P. In fact, the capacitor package structure P of the present disclosure may be the previously described winding-type solid electrolytic capacitor package structure P.

Further, referring again to FIG. 1, the capacitor package structure P includes at least one electrode having a conductive polymer coating layer. The electrode may be a winding-type negative conductive foil 12 or a winding-type positive conductive foil 11 of a winding-type solid electrolytic capacitor package structure P. More specifically, the electrode may be an anode body or a cathode body, and may each include a porous electrode material (for example, aluminum) and a dielectric formed in a thin layer.

The conductive polymer coating layer is formed by a conductive polymer dispersion, the transmittance spectrum is obtained by a UV-visible spectrometer, and the transmittance spectrum has a first peak located between 350 nm and 450 nm and a second peak located between 300 nm and 400 nm. In addition, the transmittance of the first peak P1 is less than 40%, and the transmittance of the second peak P2 is less than 35%.

In other words, the capacitor package structure P of the embodiment of the present disclosure using the conductive polymer dispersion with the above-mentioned specific peak of the transmission spectrum and the corresponding transmission. Therefore, the composition, ratio and optical characteristics of the conductive polymer dispersion will not be reiterated herein.

For example, the conductive polymer dispersion can be formed on the winding-type negative conductive foil 12 by immersion coating, spin coating, curtain coating or spray coating. Preferably, the winding-type component 1 can be immersed in the conductive polymer dispersion in a container, such that the conductive polymer dispersion is disposed on the surface of the winding-type component 1 and infiltrates into a plurality of pores of the winding-type component 1. In this way, the impregnation rate of the conductive polymer dispersion can be ensured.

In conclusion, the advantage of the present disclosure resides in that the conductive polymer dispersion for capacitor and the capacitor package structure can improve the electrical properties of the solid electrolytic capacitor based on the technical feature of “the conductive polymer dispersion has a transmittance spectrum obtained by a UV-visible spectrometry” and “the transmittance spectrum has a first peak located between 350 nm and 450 nm and a second peak located between 300 nm and 400 nm”, such as improvements of: improving conductivity, improving thermal stability, increasing polymer impregnation rate, increasing capacitance, reducing equivalent series resistance, reducing dissipation factor, and reducing leakage current, etc. In addition, the method of forming the conductive polymer dispersion of the present disclosure has low production cost, and as a result, the overall manufacturing cost of the solid electrolytic capacitor can be effectively reduced.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A conductive polymer dispersion for capacitor, wherein the conductive polymer dispersion comprises a transmittance spectrum obtained by a UV-visible spectrometry, and the transmittance spectrum has a first peak located between 350 nm and 450 nm and a second peak located between 300 nm and 400 nm.

2. The conductive polymer dispersion for capacitor according to claim 1, wherein when the conductive polymer dispersion for capacitor is diluted to 1/20 of the original concentration, the transmittance of the first peak is less than 40%, and the transmittance of the second peak is less than 35%.

3. The conductive polymer dispersion for capacitor according to claim 1, wherein when the conductive polymer dispersion for capacitor is diluted to 1/20 of the original concentration, the transmittance of the first peak is between 1% and 20%, and the transmittance of the second peak is between 2% and 16%.

4. The conductive polymer dispersion for capacitor according to claim 1, wherein when the conductive polymer dispersion for capacitor is diluted to 1/20 of the original concentration, the ratio of the transmittance of the first peak and the transmittance of the second peak is between 1:1 and 1.25:1.

5. The conductive polymer dispersion for capacitor according to claim 1, wherein the conductive polymer dispersion includes a conductive polymer, a dispersing agent and an addition agent.

6. The conductive polymer dispersion for capacitor according to claim 5, wherein the conductive polymer includes a conductive moiety and a dispersing moiety; wherein the conductive moiety is selected from the group consisting of aniline, polypyrrole, polythiophene and polydioxyethylthiophene; and the dispersing moiety is polystyrene sulfonate.

7. The conductive polymer dispersion for capacitor according to claim 5, wherein the dispersing agent is water or alcohol.

8. The conductive polymer dispersion for capacitor according to claim 5, wherein the addition agent is selected from the group consisting of a conductive auxiliary agent, pH adjusting agent, a flocculant, a thickener, adhesive and a crosslinking agent.

9. A capacitor package structure, comprising at least one electrode having a conductive polymer coating layer that is formed by a conductive polymer dispersion; wherein the conductive polymer dispersion has a transmittance spectrum obtained by a UV-visible spectrometry, and the transmittance spectrum has a first peak located between 350 nm and 450 nm and a second peak located between 300 nm and 400 nm.

10. The capacitor package structure according to claim 9, wherein when the conductive polymer dispersion for capacitor is diluted to 1/20 of the original concentration, the transmittance of the first peak is less than 40%, and the transmittance of the second peak is less than 35%.
